(19) United States
(12) Patent Application Publication
(10) Pub. No.: US 2019/0324561 A1
(43) Pub. Date: Oct. 24, 2019

(54) STYLUS WITH DISPLAY

(71) Applicant: Apple Inc., Cupertino, CA (US)

(72) Inventors: Tyler G. ANDERSON, Sunnyvale, CA (US); Hyungryul CHOI, San Jose, CA (US); Guolin PENG, Santa Clara, CA (US); Di HU, Cupertino, CA (US); Scott M. DELAPP, Sunnyvale, CA (US)

(21) Appl. No.: 16/048,127

(22) Filed: Jul. 27, 2018

Related U.S. Application Data
(60) Provisional application No. 62/662,000, filed on Apr. 24, 2018.

(51) Int. Cl. G06F 3/0354; G06F 3/039; G06F 3/038

(52) U.S. Cl. CPC G06F 3/03545; G06F 3/0383; G06F 3/039

(57) ABSTRACT

A stylus can be provided with an on-board display that indicates to a user a color that will be applied when operating the stylus with an external device. The display on the stylus can be positioned to conveniently provide an indication of the color. For example, the display can be provided at or near a tip that is used to contact the external device. The stylus can further provide an ability for the user to manually select a color, which can then be shown on the display of the stylus and transmitted to the external device for application. The stylus can further include an ability to scan a color from a physical object, with the color being shown on the display of the stylus and transmitted to the external device for application.

### CROSS-REFERENCE TO RELATED APPLICATIONS

This application claims the benefit of U.S. Provisional Application No. 62/662,000, entitled “STYLUS WITH DISPLAY,” filed Apr. 24, 2018, the entirety of which is incorporated herein by reference.

### FIELD

The present description relates generally to touch-based input devices, and, more particularly, to styluses having color selection and display capabilities.

### BACKGROUND

A variety of handheld input devices exist for detecting input from a user during use. For example, a stylus can be utilized to provide input by contacting a touch panel of an electronic device. The touch panel may include a touch sensitive surface that, in response to detecting a touch event, generates a signal that can be processed and utilized by other components of the electronic device. A display component of the electronic device may display textual and/or graphical display elements representing selectable virtual buttons or icons, and the touch sensitive surface may allow a user to navigate the content displayed on the display screen. Typically, a user can move one or more input devices, such as a stylus, across the touch panel in a pattern that the device translates into an input command.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a view of a system including a stylus and an external device.

FIG. 2 illustrates a perspective view of an example of a stylus.

FIG. 3 illustrates an exploded view of the stylus of FIG. 2.

FIG. 4 illustrates a perspective view of an example of a stylus.

FIG. 5 illustrates an exploded view of the stylus of FIG. 4.

FIG. 6 illustrates a perspective view of an example of a stylus.

FIG. 7 illustrates a block diagram of an example of a stylus and external device.

FIG. 8 illustrates a view of an example of a stylus scanning an object.

FIG. 9 illustrates a view of a system including a stylus and an external device.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Some electronic devices that include a display surface and/or a touch screen can be used in combination with a stylus or another touch-based input device. A user can operate a stylus with an external device, such as a tablet or computer, to create, edit, and/or erase representations that are recorded by and displayed on the external device. Such representations can include drawings, handwriting, text, and/or other markings based on operation of the stylus.

As a user operates the stylus, the representations displayed on the external device can have certain characteristics, such as color. However, the user may not know what color or other characteristic will be applied until after the representation has been displayed. Accordingly, it is desirable to provide the user with an early indication of the color that will be displayed.

According to embodiments disclosed herein, a stylus can be provided with a display that indicates to the user a color or another characteristic of the representations to be recorded and displayed on the external device. The display on the stylus can be positioned to conveniently provide an indication of color. For example, the display can be provided at or near a tip of the stylus that is used at a point of contact with the external device. The stylus can further provide an ability for the user to manually select a color, which can then be shown on the display of the stylus and transmitted to the external device for application. The stylus can further include an ability to scan a color from a physical object, with the color being shown on the display of the stylus and transmitted to the external device for application. These features provide the user with stylus-based control and feedback relating to the color selection for use by an external device.

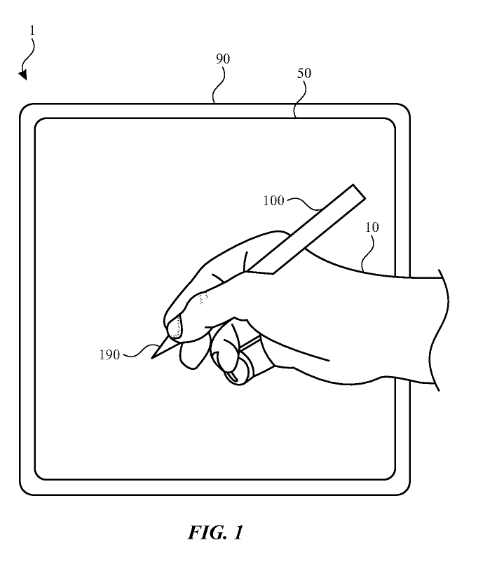

These and other embodiments are discussed below with reference to FIGS. 1-9. However, those skilled in the art will readily appreciate that the detailed description given herein with respect to these figures is for explanatory purposes only and should not be construed as limiting.

A touch-based input device in accordance with embodiments disclosed herein can include any device that is held, worn, or contacted by a user for receiving inputs from the user. The touch-based input device can be used alone or in conjunction with another device. For example, FIG. 1 illustrates a system 1 including a stylus 100 and an external device 90, having an interface surface 50, according to some embodiments of the subject technology. The stylus 100 can be held by a user 10 and operate as a touch-based input device for use with the external device 90. The interface surface 50 can include a display surface and/or a touch panel for interacting with the stylus 100 when contacted thereby. For example, the stylus 100 can include a tip 190 for contacting the interface surface 50. Such contact can be detected by the external device 90 and/or the stylus 100. For example, the stylus 100 can include one or more sensors that detect when the tip 190 contacts the interface surface 50. Such sensors can include one or more contact sensors, capacitive sensors, touch sensors, cameras, piezoelectric sensors, pressure sensors, photodiodes, and/or other sensors operable to detect contact with the interface surface 50.

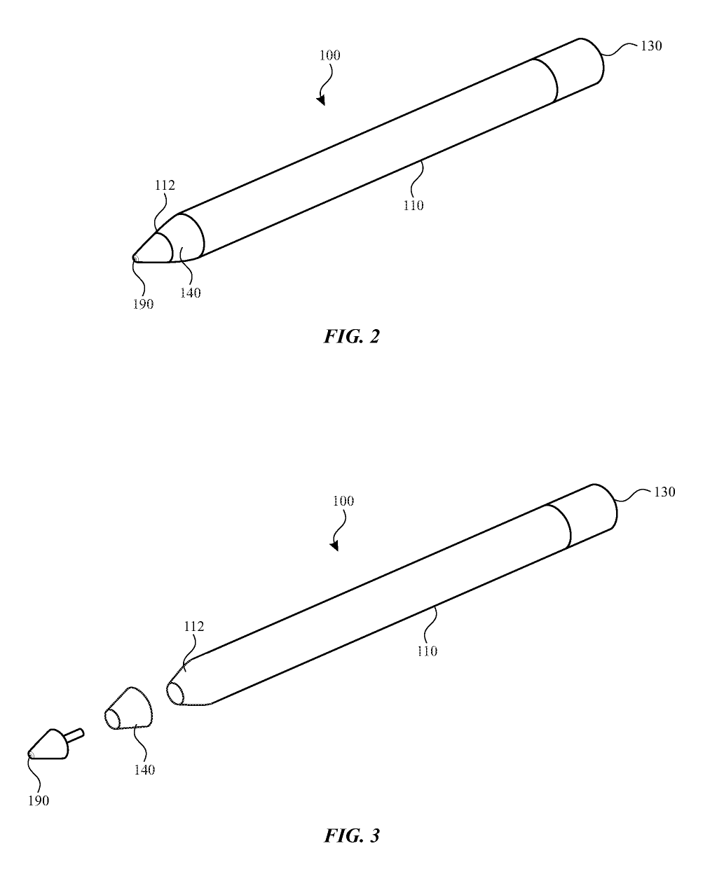

The stylus 100 can support handling and operation by a user. FIGS. 2 and 3 illustrate a stylus 100, according to some embodiments of the subject technology. As illustrated in FIGS. 2 and 3, the stylus 100 can include a body 110 that extends at least a portion of the total length of the stylus 100. A user can grip the stylus 100 at the body 110, for example near the tip 190 of the stylus 100. The stylus 100 can include a tapered end 112 that tapers, along a longitudinal length of the stylus 100, from an outer diameter of the body 110 toward a point, for example, along a central axis of the stylus 100.

Components of the stylus 100 can be positioned to receive input from the user. For example, the tip 190 can be located at a terminal end of the stylus 100. The tip 190 can include or be connected to a force sensor that detects when the tip 190 is pressed against a surface, such as the interface surface of the external device. User inputs provided to the tip 190 can generate signals that are communicated to the external device 90 for performance of an action in accordance with the signal and the user input, as discussed further herein. The tip 190 can be positioned at and/or form at least a portion of the tapered end 112 of the stylus 100.

Components of the stylus 100 can display information for a user. For example, a display 140 can be provided on an external surface of the stylus 100 to display a color or other information to a user. A displayed color can correspond to a setting of the stylus 100 and/or the external device. For example, the displayed color can be a color that is to be recorded and displayed on the external device based on operation of the stylus 100.

The display 140 can be positioned at and/or form at least a portion of the tapered end 112 of the stylus 100. For example, as illustrated in FIGS. 2 and 3, the display 140 can be positioned between the body 110 and a terminal and of the stylus 100. By further example, the display 140 can be positioned between the body 110 and the tip 190 of the stylus 100. The position of the display 140 can facilitate viewing of the display 140 by the user while the stylus 100 is held and/or operated by the user. For example, the display 140 can be positioned adjacent to, and not entirely within, a grip region of the stylus 100. Accordingly, the user can easily see the color provided on the display 140 while gripping and using the stylus 100. Furthermore, where the display 140 is near a terminal end of the stylus 100 (e.g., near the tip 190), the stylus 100 can be used with an external device in a manner that positions the display 140 of the stylus 100 near interface surface of the external device. Accordingly, the display 140 can show a color near the location at which a representation on the external device is generated in the same color. Thus, the display 140 can act as an indicator or label for the color to be generated by operation of the stylus 100.

The display 140 can form at least a portion of the tapered end 112 of the stylus 100. The display 140 can have a taper that is a continuation of another taper along the tapered end 112 (e.g., along the tip 190). For example, the display 140 and the tip 190 can each define an outer surface forming the same angle with respect to a longitudinal axis of the stylus 100. The display 140 can have a shape along the tapered end 112 that is conical or frusticonical. The display 140 can extend entirely or partially circumferentially about the longitudinal axis of the stylus 100. At least a portion of the tip 190 can extend through at least a portion of the display 140, for example to connect to a force sensor or other components within the body 110 of the stylus 100. The display 140 can be a visual output element, such as a liquid crystal display screen, electronic ink (e-ink) screen, organic light emitting diode (OLED) or diodes, light emitting diode or diodes, or the like. Where the display 140 provides a curvature, such as along the tapered end 112 of the stylus 100, a flexible OLED screen can optionally be provided to conform to the desired shape.

As further illustrated in FIGS. 2 and 3, the stylus 100 can include a color selection component 130. In some embodiments, the color selection component 130 is located at a terminal end of the stylus 100 that is located opposite the tip 190 of the stylus 100. It will be recognized that the color selection component 130 can be positioned at any other location along the stylus 100. According to some embodiments, the color selection component 130 can include a tactile sensor, such as a dial, a button, a switch, a touchpad, a touchscreen, and/or a twist mechanism that produces incremental clicks when moving between various positions. User inputs provided to the color selection component 130 can generate signals based on the color selection by a user. The signals are communicated to the display 140 for display to a user and/or to the external device for performance of an action in accordance with the signal and the user input, as discussed further herein. As the user manipulates the color selection component 130, the display 140 can be dynamically adjusted (e.g., in real time) to display colors corresponding to the user selections. For example, the display 140 can cycle through selections from a color palette as the user manipulates the color selection component 130. The display 140 can display a single color across some or all of its display area. Additionally or alternatively, the display 140 can display multiple colors and an indication of which color is selected based on the user's operation of the color selection component 130. Accordingly, the user can view dynamic updates of the color and make selections based on the color shown on the display 140.

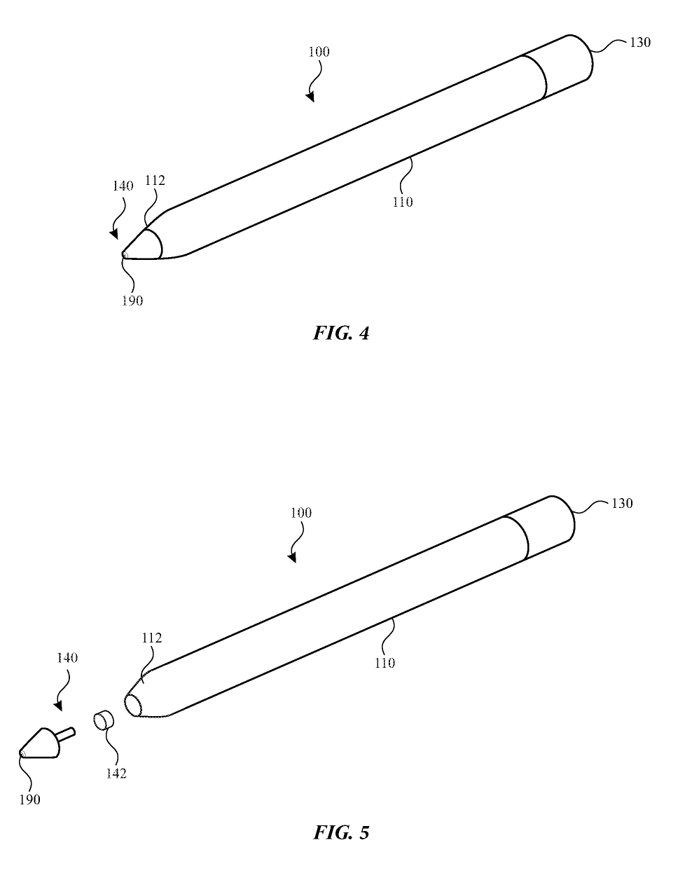

In some embodiments, the display can include or be integrated into the tip of the stylus. FIGS. 4 and 5 illustrate a stylus 100 having a display 140 that includes the tip 190. As discussed above, the tip 190 can be located at a terminal end of the stylus 100 and be used to provide inputs to the external device. The tip 190 can also provide indications of a selected color by operating as the display 140. For example, as shown in FIG. 5, the tip 190 can include or be optically connected to a light source 142. The light source 142 can provide light to the tip 190, and the tip 190 can direct at least some of the light to the user. The light can be provided with the selected color or altered to be of the selected color. The light source 142 can include multiple light emitters, such as red, green, and blue (RGB) emitters to produce a combined color based on levels of each constituent color. The light source 142 can include a light emitting diode (LED) or other type of emitter. The tip 190 can be illuminated by the light received from the light source 142. For example, the tip 190 can include a material that scatters, reflects, and/or diffuses at least some of the light. Accordingly, the tip 190 can be illuminated or glow in a color that corresponds to the selected color.

The position of the illuminable tip 190 can facilitate viewing of the selected color by the user while the stylus 100 is held and/or operated by the user. Where the tip 190 is at or near a terminal end of the stylus 100, the stylus 100 can be used with an external device in a manner that positions the tip 190 of the stylus 100 at or near the interface surface of the external device. Accordingly, the tip 190 can show the color near the location at which a representation on the external device is generated in the same color. This can produce a continuous connection between the tip 190 and the generated representation displayed on the external device. One effect of this is that the color from the tip 190 is directly applied for display on the external device, as if applied with actual paint or ink from the tip 190.

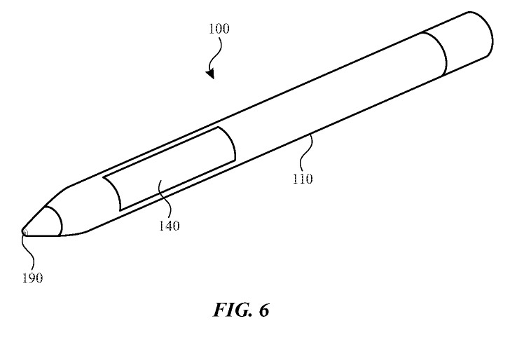

In some embodiments, a display can also be configured to facilitate user inputs for color selection. FIG. 6 illustrates a stylus 100 having a display 140 that also receives user input. For example, the display 140 can include one or more sensing elements, such as touch sensors or the like, that may detect a user input. By further example, the display 140 can detect user input of a color selection in addition to displaying the selected color. The display 140 can display multiple colors and an indication of which color is selected based on the user's operation of the display 140. The touch sensors of the display 140 can include a flexible printed circuit board, a capacitive coupling touch panel, or another touch- or force-sensitive structure. The touch sensor can overlap with the display elements of the display 140, so that the display can show multiple colors for selection by the user with the touch sensor. Alternatively or additionally, the touch sensor of the display 140 can be used to select additional selections, such as an operation of the stylus 100 and/or the external device. For example, the user can operate the display 140 to select a mode (e.g., draw, erase, edit) to be applied when the stylus 100 is applied to the external device. It will be recognized that the display 140 having a touch sensor can be positioned at any location along the stylus 100. For example, the display 140 can be provided along the body 110, at or near the tip 190, or at or near an end opposite the tip 190. Where the display 140 provides a curvature, such as about the body 110, a flexible OLED screen can optionally be provided to conform to the desired shape. A flexible screen can further facilitate detection of user inputs by a touch sensor under the flexible screen.

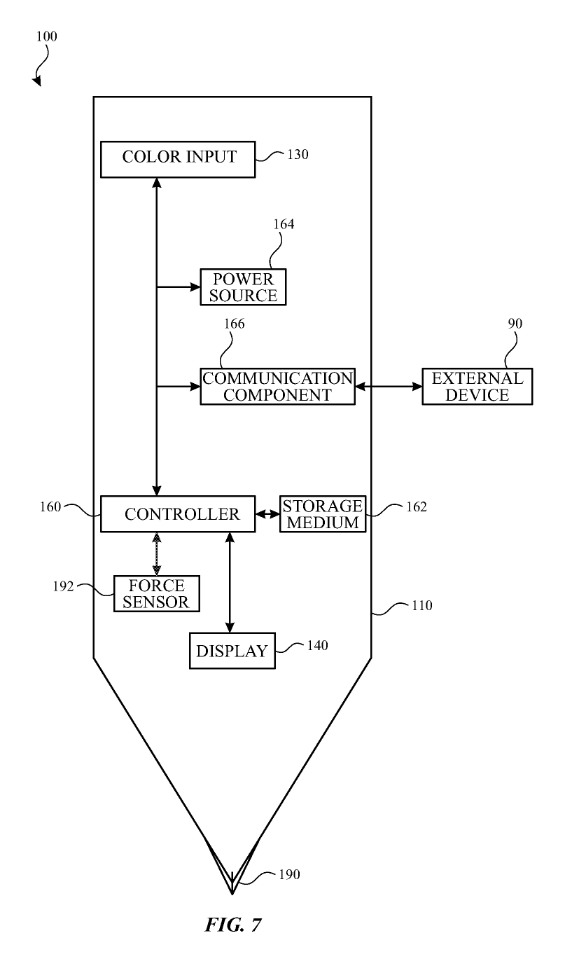

The stylus 100 can be provided with components that facilitate the operation thereof, including use with the external device 90. FIG. 7 illustrates various components of the stylus 100, according to some embodiments of the subject technology.

As shown in FIG. 7, the stylus 100 can include the force sensor 192 at a tip 190 of the stylus 100 for sensing when the tip 190 is contacting a surface, such as the interface surface 50 of the external device 90. The force sensor 192 can be connected to or integrated with the tip 190. The force sensor 192 and/or the tip 190 can include one or more contact sensors, capacitive sensors, touch sensors, cameras, piezoelectric sensors, pressure sensors, photodiodes, and/or other sensors.

As further shown in FIG. 7, the stylus 100 can include a controller 160 and non-transitory storage media 162. The non-transitory storage media 162 can include, for example, a magnetic storage medium, optical storage medium, magneto-optical storage medium, read-only memory, random access memory, erasable programmable memory, flash memory, or combinations thereof. According to some embodiments, the controller 160 can execute one or more instructions stored in the non-transitory storage media 162 to perform one or more functions, such as those discussed further herein.

According to some embodiments, the stylus 100 can include a communication component 166 for communicating with the external device 90. The communication component 166 can include one or more wired or wireless components, WiFi components, near field communication components, Bluetooth components, and/or other communication components. The communication component 166 can include one or more transmission elements, such as one or more antennas. Alternatively or in combination, the communication component 166 can include an interface for a wired connection to the external device 90.

According to some embodiments, the stylus 100 can include a power source 164, such as one or more batteries and/or power management units. The stylus 100 can include components for charging the power source 164.

According to some embodiments, the stylus 100 can include other components including, for example, orientation detectors, gyroscopes, accelerometers, biometric readers, displays, sensors, switches (e.g., dome switches), buttons, speakers, microphones, cameras, voice coils, haptic feedback devices, and/or other components.

The tip 190 of the stylus 100 can be used for virtually creating, editing, and/or erasing representations while drawing or writing on a surface. The stylus 100 can be used for drawing or writing by contacting the interface surface of the external device 90 with the tip 190 of the stylus 100. According to some embodiments, the tip 190, the color selection component 130, and/or the display 140 can detect tactile input from a user. For example, the tip 190 can be used to contact the interface surface of the external device 90. When the tip 190 contacts the interface surface, the external device 90 can record and/or display a representation at the location of contact with the tip 190. The external device 90 can detect the contact and/or receive a communication from the stylus 100 regarding usage of the tip 190.

The tip 190, the color selection component 130, and/or the display 140 of the stylus 100 can be used to change settings of the external device 90. According to some embodiments, a user can provide primary inputs via the tip 190 and secondary inputs via the color selection component 130 and/or the display 140. While the stylus 100 is used for drawing or writing, inputs provided with the tip 190 can be recorded by the external device 90 with representations, lines, or shapes having a variety of characteristics, including a selected color. When the user operates the color selection component 130 and/or the display 140 to create a signal, the external device 90 can interpret the signal as a command to apply one or more characteristics to representations generated by subsequent input from the stylus 100. Accordingly, subsequent contact between the tip 190 of the stylus 100 and the interface surface of the external device 90 can be recorded and/or displayed as representations having the one or more user-selected characteristics determined by use of the color selection component 130 and/or the display 140.

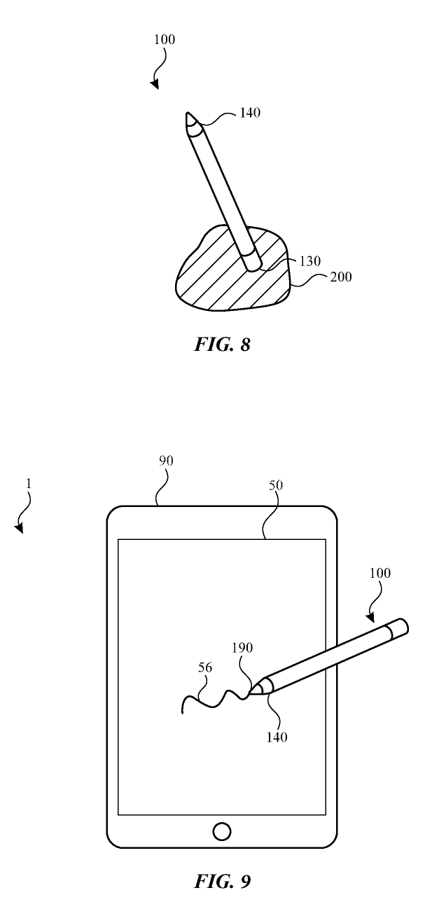

FIGS. 8 and 9 illustrate operation of a stylus to detect and apply a color. According to some embodiments, the color selection component 130 of the stylus 100 can include an optical sensor for detecting a color of a sample. As shown in FIG. 8, the user can bring the color selection component 130 to an object 200, and the stylus 100 can record the color of the object 200. The color selection component 130 can include a spectrometer, a camera, and/or an RGB optical sensor. The color selection component 130 can further include a light emitter to facilitate scanning and/or one or more light guides to direct light from the object 200 to a sensor. It will be recognized that the color selection component 130 can be positioned at any location along the stylus 100. For example, the color selection component 130 can be provided at or near an end opposite the tip 190, along a body 110, or at or near the tip 190.

A color obtained by a scan with the color selection component 130 is used to generate signals based on the color. The signals are communicated to the display 140 for display to a user and/or to the external device 90 for performance of an action in accordance with the signal and the scanned color. For example, the display 140 can show one of more scanned colors. The color shown on the display can be shown during and/or after a scan operation of the color selection component 130. For example, the display can be dynamically updated as the color selection component 130 scans different portions of the object. The stylus 100 can also transmit the color to the external device 90. Where the external device 90 includes a display on the interface surface 50, the user can apply the scanned color to at least a portion of the interface surface 50. For example, as shown in FIG. 9, the tip 190 of the stylus 100 can be used to contact the interface surface 50 of the external device 90. A corresponding representation 56 is recorded and displayed on the interface surface 50 at the location of the tip 190. According to some embodiments, the color of the sample can be applied to the representation 56 that is displayed on the external device 90. Thus, the same color can be scanned by the color selection component 130, displayed on the display 140 of the stylus 100, and applied to the representation 56 that is displayed on the external device 90.

While portions of the above description relates to selection of color, it will be recognized that other characteristics, including other visual aspects, can be selected, displayed, and applied. For example, the selection, display, and application can relate to a brightness, opacity, shading, gradient, texture, size, proportions,

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device as described herein for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A stylus comprising:
a color selection component configured to receive a user selection of a color;
a display configured to display the color based on the user selection; and
a communication component for transmitting the user selection of the color to an external device, wherein the external device is configured to display a representation in the color and based on a user input.

2. The stylus of claim 1, wherein the color selection component is a touch sensor overlapping the display, and wherein the display is configured to display multiple colors for selection by a user with the touch sensor.

3. The stylus of claim 1, wherein the color selection component is a dial, and wherein the display changes the color based on a user-selected setting of the dial.

4. The stylus of claim 1, wherein the color selection component is configured to receive an additional user selection, wherein the communication component is configured to transmit the additional user selection to the external device, and wherein the external device is configured to display the representation based on the additional user selection.

5. The stylus of claim 4, wherein the additional user selection corresponds to an operation of the external device.

6. The stylus of claim 1, further comprising:
a tip; and
a force sensor connected to the tip and configured to detect a force applied to the tip, wherein the communication component is further configured to communicate to the external device a force indicator of the force detected by the force sensor, and wherein the external device is further configured to display the representation based on the force indicator.

7. The stylus of claim 1, wherein the display comprises an flexible OLED screen.

8. A stylus comprising:
a body;
a display configured to display a color based on a user selection, wherein the display defines at least part of a tapered end separate from the body and configured to receive a user input; and
a communication component for communicating the user selection of the color between the stylus and an external device, wherein the external device is configured to display a representation in the color and based on the user input.

9. The stylus of claim 8, further comprising a force sensor, wherein the tapered end comprises a tip moveable with respect to the body and connected to the force sensor for detecting a force applied to the tip, and wherein at least a portion of the tip extends through at least a portion of the display.

10. The stylus of claim 9, wherein the display is between the tip and the body, and wherein the display and the tip each define an outer surface forming the same angle with respect to a longitudinal axis of the stylus.

11. The stylus of claim 9, wherein the communication component is further configured to communicate to the external device a force indicator of the force detected by the force sensor, and wherein the external device is further configured to display the representation based on the force indicator.

12. The stylus of claim 8, wherein the display forms a frusticonical shape.

13. The stylus of claim 8, wherein the display is circumferentially continuous about a longitudinal axis of the stylus.

14. The stylus of claim 8, wherein the display comprises a flexible OLED screen.

15. The stylus of claim 8, wherein the display comprises:
a light source; and
a tip configured to diffuse light from the light source and direct the diffused light to a user.

16. The stylus of claim 8, wherein the display comprises a tip at a terminal end of the stylus, the tip being configured to generate a signal when applied to the external device.

17. A stylus comprising:
an optical sensor configured to optically scan a color of an object;
a display configured to display the color; and
a communication component for transmitting an indication of the color to an external device, wherein the external device is configured to display a representation in the color and based on a user input.

18. The stylus of claim 17, further comprising:
a tip; and
a force sensor connected to the tip and configured to detect a force applied to the tip, wherein the communication component is further configured to communicate to the external device a force indicator of the force detected by the force sensor, and wherein the external device is further configured to display the representation based on the force indicator.

19. The stylus of claim 18, wherein the optical sensor is positioned on an end of the stylus that is opposite the tip.

20. The stylus of claim 18, wherein at least a portion of the optical sensor is positioned in the tip.
